(19) United States
(12) Patent Application Publication
(10) Pub. No.: US 2025/0246724 A1
(43) Pub. Date: Jul. 31, 2025

(54) CYLINDRICAL SECONDARY BATTERY

(71) Applicant: MURATA MANUFACTURING CO., LTD., Kyoto (JP)

(72) Inventors: Yukio SASAGAWA, Kyoto (JP); Yoshihito INOUE, Kyoto (JP)

(21) Appl. No.: 18/938,535

(22) Filed: Nov. 6, 2024

(30) Foreign Application Priority Data
Jan. 30, 2024 (JP) 2024-012064

(51) Int. Cl. H01M 50/107; H01M 50/121; H01M 50/124

(52) U.S. Cl. CPC H01M 50/107; H01M 50/121; H01M 50/1245

(57) ABSTRACT

A cylindrical secondary battery is provided and includes a cylindrical exterior portion including a battery element therein and including opposite end portions and an outer peripheral surface disposed therebetween; and a covering portion covering at least a part of both the end portions of the exterior portion and an entire outer peripheral surface, wherein the exterior portion includes a cylindrical main body having an opening on one end side and a bottom on another end side opposite to the one end side, and a lid closing the opening, a calculated average roughness (Ra) of the cylindrical main body is 0.7 to 1.5 μm, and a maximum height roughness (Rz) of an inner surface of the covering portion in a radial direction of the bottom of the main body is 2.5 μm or less.

### CROSS REFERENCE TO RELATED APPLICATION

The present application claims priority to Japanese patent application no. 2024-012064, filed on Jan. 30, 2024, the entire contents of which is incorporate herein by reference.

### BACKGROUND

The present disclosure relates to a cylindrical secondary battery.

Conventionally, a cylindrical secondary battery has been used. As the cylindrical secondary battery, one including a cylindrical exterior portion including a battery element therein and a covering portion (corresponding to a heat shrinkable tube or film) covering the surface of the exterior portion is known.

### SUMMARY

The present disclosure relates to a cylindrical secondary battery.

There are matters to be improved in the conventional cylindrical secondary battery including, for example, as noted in the following points.

Specifically, in the conventional cylindrical secondary battery, there may be a case where adhesion between a cylindrical exterior portion as a constituent element thereof and a covering portion covering the surface of the cylindrical exterior portion is not sufficient. In this case, moisture enters between the exterior portion and the covering portion on the bottom side of the exterior portion, and a so-called tracking phenomenon occurs due to this, and as a result, the short circuit of the battery may occur.

The present disclosure, in an embodiment, relates to providing a cylindrical secondary battery capable of improving adhesion between an exterior portion and a covering portion.

In an embodiment, the present disclosure relates to a cylindrical secondary battery including: a cylindrical exterior portion including a battery element therein and including opposite end portions and an outer peripheral surface disposed therebetween; and a covering portion covering at least a part of both the end portions of the exterior portion and the entire outer peripheral surface, wherein the exterior portion includes a cylindrical main body having an opening on one end side and a bottom on another end side opposite to the one end side, and a lid closing the opening, a calculated average roughness (Ra) of the cylindrical main body is 0.7 to 1.5 μm, and a maximum height roughness (Rz) of an inner surface of the covering portion in a radial direction of the bottom of the main body is 2.5 μm or less.

According to the cylindrical secondary battery of the present disclosure, in an embodiment, it is possible to improve the adhesion between the exterior portion and the covering portion.

### BRIEF DESCRIPTION OF THE FIGURES

FIG. 1 is a schematic perspective view of a cylindrical secondary battery according to an embodiment of the present disclosure;

FIG. 2 is a schematic sectional view of a cylindrical secondary battery according to an embodiment of the present disclosure taken along a battery longitudinal direction in FIG. 1;

FIG. 3 is a schematic perspective view of a cylindrical secondary battery of Comparative Example;

FIG. 4 is a schematic sectional view of a cylindrical secondary battery of Comparative Example taken along a battery longitudinal direction in FIG. 3;

FIG. 5 is a schematic sectional view of a cylindrical secondary battery subjected to a tracking short circuit test; and

FIG. 6 is a sectional view schematically illustrating the structure of a positive electrode and a negative electrode.

### DETAILED DESCRIPTION

The present disclosure will be described in further detail including with reference to the drawings according to an embodiment. Although description will be made with reference to the drawings as necessary, various elements in the drawings are merely schematically and exemplarily shown for understanding of the present disclosure, and appearance and a dimensional ratio and the like can be different from those of actual ones.

The term “secondary battery” in the present specification means a battery that can be repeatedly charged and discharged. The “secondary battery” is not unduly restricted by the name of the secondary battery, which can encompass, for example, a “power storage device” and the like.

Various numerical ranges referred to herein are intended to include lower limit and upper limit numerical values themselves, unless otherwise noted, such as “less than” or “greater than/larger than”. That is, when a numerical range such as 1 to 10 is taken as an example, it can be interpreted as including “1” as a lower limit and also including “10” as an upper limit. Further, terms such as “about” and “degree” mean that they may include variation of a few percent, for example, ±10%.

The term “sectional view” in the present specification refers to a state when an object (cylindrical secondary battery) is taken along the longitudinal direction. The term “perspective” in the present specification refers to a state when the external appearance (in particular, the external appearance of a bottom and a side portion) of an object (cylindrical secondary battery) is viewed from an oblique direction.

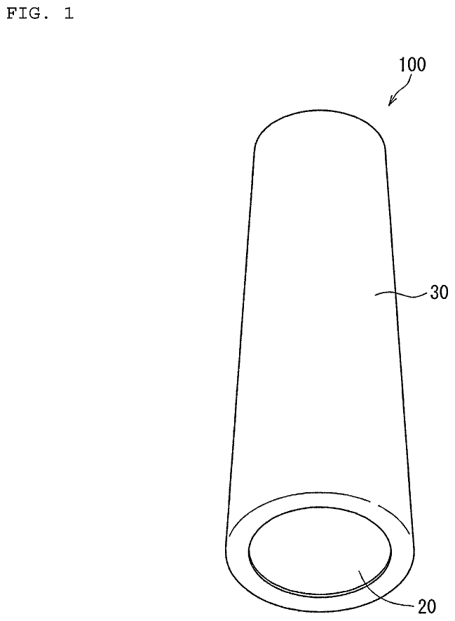

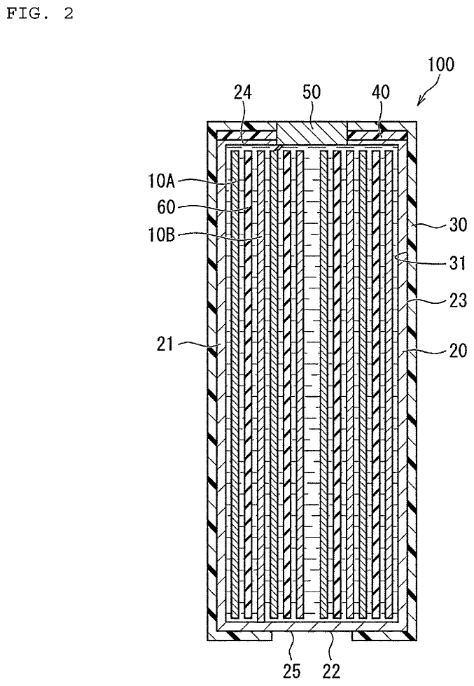

Hereinafter, the overall configuration of the cylindrical secondary battery according to an embodiment of the present disclosure will be described. FIG. 1 is a schematic perspective view of a cylindrical secondary battery according to an embodiment of the present disclosure. FIG. 2 is a schematic sectional view of a cylindrical secondary battery according to an embodiment of the present disclosure taken along a battery longitudinal direction in FIG. 1.

As shown in FIGS. 1 and 2, a cylindrical secondary battery 100 according to an embodiment of the present disclosure includes a cylindrical exterior portion 20 including a battery element therein, and a covering portion 30 covering the surface of the exterior portion 20.

In the exterior portion 20, the above-described battery element (corresponding to an electrode assembly) is housed, and an electrolyte is sealed. The electrode assembly may include a positive electrode, a negative electrode, and a separator disposed between the positive electrode and the negative electrode. The electrode assembly may be a stacked electrode assembly or a wound (jelly roll type) electrode assembly. The stacked electrode assembly is obtained by stacking a plurality of electrode constituting layers each including a positive electrode, a negative electrode, and a separator. The wound electrode assembly is obtained by winding a plurality of electrode constituting layers each including a positive electrode, a negative electrode, and a separator. In addition, for example, the electrode assembly may have a so-called stack and folding structure, in which the positive electrode, the separator, and the negative electrode are stacked on a long film, and then folded.

A positive electrode 10A includes at least a positive electrode current collector 11A and a positive electrode material layer 12A (see FIG. 6), and the positive electrode material layer 12A is provided on at least one surface of the positive electrode current collector 11A. At a site of the positive electrode current collector 11A without the positive electrode material layer 12A provided, that is, an end of the positive electrode current collector 11A, a positive electrode-side extended tab is positioned. The positive electrode material layer 12A contains therein a positive electrode active material as an electrode active material. A negative electrode 10B includes at least a negative electrode current collector 11B and a negative electrode material layer 12B (see FIG. 6), and the negative electrode material layer 12B is provided on at least one surface of the negative electrode current collector 11B. At a site of the negative electrode current collector 11B without the negative electrode material layer 12B provided, that is, an end of the negative electrode current collector 11B, a negative electrode-side extended tab is positioned. The negative electrode material layer 12B contains therein a negative electrode active material as an electrode active material.

The positive electrode active material included in the positive electrode material layer 12A and the negative electrode active material included in the negative electrode material layer 12B are substances directly involved in the transfer of electrons in the secondary battery and are main substances of the positive and negative electrodes that involve a battery reaction such as charge-discharge. More specifically, ions are brought into the electrolyte due to “the positive electrode active material included in the positive electrode material layer 12A” and “the negative electrode active material included in the negative electrode material layer 12B”, and such ions move between the positive electrode 10A and the negative electrode 10B to transfer electrons, thereby leading to charge-discharge. The positive electrode material layer 12A and the negative electrode material layer 12B are preferably layers capable of occluding and releasing, in particular, lithium ions. More specifically, a secondary battery is preferred in which lithium ions move between the positive electrode 10A and the negative electrode 10B through the electrolyte to charge and discharge the battery. When lithium ions are involved in charge-discharge, the secondary battery corresponds to a so-called “lithium ion battery”.

The positive electrode active material of the positive electrode material layer 12A contains, for example, a granular material, and a binder is preferably included in the positive electrode material layer 12A for more sufficient contact between grains and shape retention. Furthermore, a conductive auxiliary agent may be included in the positive electrode material layer 12A to facilitate transfer of electrons that promotes the battery reaction. Similarly, the negative electrode active material of the negative electrode material layer 12B contains, for example, a granular material, a binder is preferably included for more sufficient contact between grains and shape retention, and a conductive auxiliary agent may be included in the negative electrode material layer 12B to facilitate transfer of electrons that promotes the battery reaction. The positive electrode material layer 12A and the negative electrode material layer 12B can also be referred to as “positive electrode mixture layer” and “negative electrode mixture layer”, respectively, because multiple components are contained therein.

It is preferable that the positive electrode active material be a material contributing to occlusion and release of lithium ions. From such a viewpoint, the positive electrode active material is preferably, for example, a lithium-containing composite oxide. More specifically, the positive electrode active material is preferably a lithium-transition metal composite oxide containing lithium and at least one transition metal selected from the group consisting of cobalt, nickel, manganese, and iron. In other words, such a lithium-transition metal composite oxide is preferably included as a positive electrode active material in the positive electrode material layer 12A of the secondary battery. For example, the positive electrode active material may be lithium cobaltate, lithium nickelate, lithium manganate, lithium iron phosphate, or a material obtained by replacing a part of the transition metal thereof with another metal. Such positive electrode active materials may be included as a single species, or two or more species thereof may be included in combination. In a more preferred aspect, the positive electrode active material contained in the positive electrode material layer 12A is lithium cobaltate.

The binder that can be included in the positive electrode material layer 12A is not particularly limited, and examples of the binder include at least one selected from the group consisting of polyvinylidene fluoride, a vinylidene fluoride-hexafluoropropylene copolymer, a vinylidene fluoride-tetrafluoroethylene copolymer, polytetrafluoroethylene, and the like. The conductive auxiliary agent that can be included in the positive electrode material layer 12A is not particularly limited, and examples thereof include at least one selected from carbon black such as thermal black, furnace black, channel black, ketjen black, and acetylene black, carbon fibers such as graphite, carbon nanotubes, and vapor-grown carbon fibers, metal powders such as copper, nickel, aluminum, and silver, and polyphenylene derivatives. For example, the binder of the positive electrode material layer 12A may be polyvinylidene fluoride. By way of example only, the conductive auxiliary agent of the positive electrode material layer 12A is carbon black. Furthermore, the binder and conductive auxiliary agent of the positive electrode material layer 12A may be a combination of polyvinylidene fluoride and carbon black.

The negative electrode active material is preferably a material that contributes to occlusion and release of lithium ions. From such a viewpoint, the negative electrode active material is preferably, for example, various carbon materials, oxides, lithium alloys, or the like.

Examples of the various carbon materials for the negative electrode active material include graphite (natural graphite and artificial graphite), soft carbon, hard carbon, and diamond-like carbon. In particular, graphite is preferred in terms of high electron conductivity and excellent adhesiveness to the negative electrode current collector 11B. Examples of the oxides for the negative electrode active material include at least one selected from the group consisting of silicon oxide, tin oxide, indium oxide, zinc oxide, and lithium oxide. The lithium alloy for the negative electrode active material may be any metal that can be alloyed with lithium, and may be, for example, a binary, ternary, or higher alloy of lithium and a metal such as Al, Si, Pb, Sn, In, Bi, Ag, Ba, Ca, Hg, Pd, Pt, Te, Zn, or La. Such an oxide is preferably amorphous as its structural form. This is because deterioration due to nonuniformity such as crystal grain boundaries or defects is less likely to be caused. By way of example only, the negative electrode active material of the negative electrode material layer 12B may be artificial graphite.

The binder that can be included in the negative electrode material layer 12B is not particularly limited, and examples thereof include at least one selected from the group consisting of a styrene butadiene rubber, a polyacrylic acid, a polyvinylidene fluoride, a polyimide-based resin, and a polyamideimide-based resin. For example, the binder included in the negative electrode material layer 12B may be a styrene-butadiene rubber. The conductive auxiliary agent that can be included in the negative electrode material layer 12B is not particularly limited, and examples thereof include at least one selected from: carbon black such as thermal black, furnace black, channel black, ketjen black, and acetylene black; carbon fibers such as graphite, carbon nanotubes, and vapor grown carbon fibers; metal powders such as copper, nickel, aluminum, and silver; and polyphenylene derivatives. The negative electrode material layer 12B may include therein a component derived from a thickener component (for example, a carboxymethyl cellulose) used in manufacturing the battery.

By way of example only, the negative electrode active material and binder in the negative electrode material layer 12B may be a combination of artificial graphite and styrene-butadiene rubber.

The positive electrode current collector 11A and the negative electrode current collector 11B used for the positive electrode 10A and the negative electrode 10B are members that contribute to collecting and supplying electrons generated in the active materials due to the battery reaction. Such a current collector may be a metal member in a sheet form, and may have a porous or perforated form. For example, the current collector may be a metal foil, a punching metal, a net, an expanded metal, or the like. The positive electrode current collector 11A used for the positive electrode 10A is preferably a metal foil containing at least one selected from the group consisting of aluminum, stainless steel, nickel, and the like, and may be, for example, an aluminum foil. In contrast, the negative electrode current collector 11B used for the negative electrode 10B is preferably a metal foil containing at least one selected from the group consisting of copper, stainless steel, and nickel, and may be, for example, a copper foil.

The separator is a member provided from the viewpoint of preventing a short circuit due to contact between the positive and negative electrodes, holding the electrolyte, and the like. In other words, the separator can be a member that allows ions to pass while preventing electronic contact between the positive electrode 10A and the negative electrode 10B. Preferably, the separator is a porous or microporous insulating member, and has a membrane form due to its small thickness. Although it is merely an example, a microporous membrane formed of polyolefin may be used as the separator. In this respect, the microporous membrane for use as the separator may contain, for example, only polyethylene (PE) or only polypropylene (PP) as the polyolefin. Furthermore, the separator may be a laminated body including a “microporous membrane formed of PE” and a “microporous membrane formed of PP”. The surface of the separator may be covered with an inorganic particle coating layer and/or an adhesive layer or the like. The surface of the separator may have adhesiveness.

The separator should not be particularly restricted by its name, and may be a solid electrolyte, a gel-like electrolyte, insulating inorganic particles, and the like that have a similar function. Further, from the viewpoint of further improving handling of the electrodes, the separator and the electrodes (positive electrode 10A/negative electrode 10B) are preferably bonded with each other. The separator can be bonded to the electrode by using an adhesive separator as the separator, by application and/or thermocompression bonding of an adhesive binder onto the electrode material layer (positive electrode material layer 12A/negative electrode material layer 12B), or the like. Examples of the material of the adhesive binder that provides adhesiveness to the separator or the electrode material layer include polyvinylidene fluoride, a vinylidene fluoride-hexafluoropropylene polymer, and an acrylic resin. The thickness of the adhesive layer by the adhesive binder application or the like may be 0.5 μm or more and 5 μm or less.

When the positive electrode 10A and the negative electrode 10B include a layer capable of occluding and releasing lithium ions, the electrolyte is preferably a “nonaqueous” electrolyte such as an organic electrolyte and/or an organic solvent (that is, the electrolyte is preferably a nonaqueous electrolyte). In the electrolyte, metal ions released from the electrodes (positive electrode 10A/negative electrode 10B) will be present, and the electrolyte will thus assist the movement of the metal ions in the battery reaction.

The nonaqueous electrolyte is an electrolyte including a solvent and a solute. As a specific solvent for the nonaqueous electrolyte, a solvent containing at least a carbonate is preferred. Such a carbonate may be cyclic carbonates and/or chain carbonates. Although not particularly limited, examples of the cyclic carbonates include at least one selected from the group consisting of a propylene carbonate (PC), an ethylene carbonate (EC), a butylene carbonate (BC), and a vinylene carbonate (VC). Examples of the chain carbonates include at least one selected from the group consisting of a dimethyl carbonate (DMC), a diethyl carbonate (DEC), an ethyl methyl carbonate (EMC), and a dipropyl carbonate (DPC). By way of example only, a combination of the cyclic carbonates and the chain carbonates is used as the nonaqueous electrolyte, and for example, a mixture of ethylene carbonate and diethyl carbonate may be used. In addition, as a specific solute for the nonaqueous electrolyte, for example, an Li salt such as LiPF₆ or LiBF₄ is preferably used. In addition, as a specific solute for the nonaqueous electrolyte, for example, an Li salt such as LiPF₆ and/or LiBF₄ is preferably used.

As the positive electrode current collecting lead and the negative electrode current collecting lead, it is possible to use any current collecting lead that is used in the field of secondary batteries. Such a current collecting lead may contain a material that can achieve the movement of electrons, and contains, for example, a conductive material such as aluminum, nickel, iron, copper, and stainless steel. The positive electrode current collecting lead preferably contains aluminum, and the negative electrode current collecting lead preferably contains nickel. The forms of the positive electrode current collecting lead and negative electrode current collecting lead are not particularly limited, and may be, for example, a wire or plate shape.

As the exterior portion 20, a cylindrical portion with a bottom can be used. Specifically, the exterior portion 20 includes a main body 21 and a lid 24.

The main body 21 includes a bottom 22 constituting the bottom surface of the exterior portion 20 and a side surface portion 23. That is, the main body 21 is a cylindrical member in which one end side is opened and the other end side opposed thereto is the bottom 22. The side surface portion 23 has an outer peripheral surface disposed between both end sides facing each other.

The covering portion 30 covers at least a part of both end portions of the exterior portion 20 and the entire outer peripheral surface of the side surface portion 23. The lid 24 is configured to close the opening of the main body 21. The main body 21 and the lid 24 are sealed after the battery element, the electrolyte, the current collecting leads, and the external terminals are housed. Under such a configuration, in the cylindrical secondary battery, the bottom 22 of the exterior portion 20 as both end surfaces and the electrode provided on the lid 24 are used as positive and negative electrode terminals.

The sealing method is not particularly limited, and examples thereof include a laser irradiation method. As a material constituting the main body 21 and the lid 24, it is possible to use any material that can constitute a hard case type exterior portion in the field of secondary batteries. Such a material may be any material that can achieve the movement of electrons, and examples of the material can include conductive materials such as aluminum, nickel, iron, copper, and stainless steel.

The dimensions of the main body 21 and lid 24 are determined mainly depending on the dimension of the electrode assembly, and for example, the main body 21 and the lid 24 preferably have such a dimension that the movement or displacement of the electrode assembly within the exterior portion 20 is prevented when the electrode assembly is housed. Preventing the movement of the electrode assembly prevents the electrode assembly from being broken, and improves the safety of the secondary battery.

The covering portion 30 is a constituent member that covers the surface of the exterior portion 20 as described above. The region covered with the covering portion 30 can be the entire surface of the side surface portion 23 of the exterior portion 20, a part of the bottom 22 of the exterior portion 20, and a portion other than the arrangement portion of the electrode terminal in the lid 24 of the exterior portion 20. As the covering portion 30, a heat shrinkable tube can be used. As the heat shrinkable tube, for example, a polyester-based resin can be used. Among them, saturated crystalline polyethylene terephthalate (PET) can be used as an example. The covering portion 30 may have a thickness of 30 μm or more and 150 μm or less.

On the premise of the above configuration, a cylindrical secondary battery 100 of the present disclosure is characterized in an interface portion between the exterior portion 20 and the covering portion 30. In particular, the present disclosure is characterized in the interface portion between the bottom 22 of the exterior portion 20 and the covering portion 30. Specifically, the cylindrical secondary battery 100 of the present disclosure is characterized in that, when the calculated average roughness (Ra) of the cylindrical main body 21 is 0.7 to 1.5 μm, the maximum height roughness (Rz) of the inner surface 31 of the covering portion 30 in the radial direction of the battery is 2.5 μm or less.

The term “maximum height roughness (Rz)” in the present specification refers to a numerical value obtained by quantifying the highest peak within the range of the reference length of a sectional curve based on the JIS standard regarding surface roughness (JIS B 0601: 2001). That is, the maximum height roughness (Rz) is a value obtained by taking a difference between the lowest concave portion and the highest convex portion in the specified length.

The maximum height roughness (Rz) is used to be distinguished from the calculated average roughness (Ra) and ten-point average roughness (Rzjis) used as indexes indicating the surface roughness.

The term “calculated average roughness (or average surface roughness) (Ra)” in the present specification refers to a numerical value indicating, on average, a difference between irregularities of a specified length. The ten-point average roughness (Rzjis) is a value obtained by averaging 10 points in total, that is, from the lowest concave point to the fifth concave point and from the highest convex point to the fifth convex point in the specified length.

According to the above feature of the present disclosure, when the calculated average roughness (Ra) of the cylindrical main body 21 is 0.7 to 1.5 μm, adhesion between the inner surface 31 of the covering portion 30 and the surface 25 of the exterior portion 20 in the radial direction of the battery can be improved as compared with a case where Rz exceeds 2.5 μm. Specifically, it is possible to improve the adhesion between the inner surface 31 of the covering portion 30 and the surface 25 of the bottom 22 of the exterior portion 20 in the radial direction of the battery.

By such improvement in adhesion, moisture infiltration from the bottom 22 of the exterior portion 20 into between the exterior portion 20 and the covering portion 30 can be suppressed. That is, it is possible to suppress the rising of moisture from the bottom 22 of the exterior portion 20 through between the exterior portion 20 and the covering portion 30.

As a result, a so-called tracking phenomenon is suppressed, and the occurrence of a short circuit in the cylindrical secondary battery 100 can be suitably suppressed. The occurrence of rust in the exterior portion 20 can also be suitably suppressed by suppressing the moisture infiltration. From the above, the covering portion 30 of the inner surface 31 in which Rz is set to a predetermined value or less can suitably function as a moisture infiltration suppression member.

In this respect, the technical approach of the present disclosure is different from the conventional aspect in which the calculated average roughness (Ra) and/or the ten-point average roughness (Rzjis) is focused in order to improve the insertability of the heat shrinkable tube as the covering portion into the exterior portion and to suppress the decrease in the unwinding property of the heat shrinkable film used as the covering portion, in that the present disclosure also focuses on Rz in order to suppress the moisture infiltration.

In the cylindrical secondary battery 100 of the present disclosure, a washer member 40 that covers the lid 24 of the exterior portion 20 is disposed on the top surface or the top surface side except for the exposed portion of the electrode terminal, and the covering portion 30 may be disposed so as to cover the washer member 40. The washer member 40 reduces the exposed area of the lid 24 of the exterior portion 20 and suppresses a short circuit between the main body 21 of the exterior portion 20 and the lid 24.

In addition, in the present disclosure, the maximum height roughness (Rz) of the inner surface 31 of the covering portion 30 in the longitudinal direction of the battery is preferably 2.0 μm or less. As a result, as compared with the case where Rz is more than 2.0 μm, it is possible to improve the adhesion between the inner surface 31 of the covering portion 30 and the surface 25 of the exterior portion 20 in the longitudinal direction of the battery.

That is, it is possible to improve the adhesion between the inner surface 31 of the covering portion 30 and the surface 25 of the side surface portion 23 of the exterior portion 20 in the longitudinal direction of the battery. With such an improvement in adhesion, it is possible to suitably suppress the moisture from further rising through between the side surface portion 23 of the exterior portion 20 and the covering portion 30.

In the present disclosure, from the viewpoint of improving the adhesion between the inner surface 31 of the covering portion 30 and the surface 25 of the exterior portion 20, it is preferable that not only the inner surface 31 of the covering portion 30 but also the surface of the exterior portion 20 have a maximum height roughness (Rz) of a predetermined value or less. For example, Rz may be 1.5 μm or less. As the covering portion 30, a resin member having heat shrinkability can be used as described above, while the exterior portion 20 can be a metal member. Therefore, Rz is relatively low due to the processing aspect of the exterior portion 20 and/or the nature of the constituent material and the like.

The cylindrical secondary battery of the present disclosure can be finally obtained by inserting the heat shrinkable tube as the covering portion into the exterior portion including the battery element and an electrolytic solution therein, applying heat using a heater, and shrinking and attaching the tube to the surface of the exterior portion.

While an embodiment of the present disclosure has been described herein, a typical example in the applicable scope of the present disclosure has been merely provided, and thus, the present disclosure is not limited thereto, and various modifications can be made.

For example, from the viewpoint of suppressing the moisture infiltration, in addition to the above-described measure of setting Rz to a predetermined value or less, the contour of the bottom of the exterior portion 20 and the area covering the peripheral portion thereof may be made relatively large. In this case, for example, about 10% or more and about 20% or less of the bottom of the exterior portion 20 may be covered with the covering portion.

### EXAMPLES

Hereinafter, Examples will be described according to an embodiment.

### Example 1

First, a heat shrinkable tube as a covering portion was inserted into the exterior portion including a battery element and an electrolytic solution therein, and the tube was shrunk and attached to the surface of the exterior portion by heat of a heater to prepare a predetermined cylindrical secondary battery.

Specifically, the following was used as the cylindrical secondary battery.
Covering portion (heat shrinkable tube):
   Rz of inner surface in each of battery radial direction and longitudinal direction: 2.5 μm
   Material: PET, Thickness: 100 μm·Exterior portion: Material: Ni-plated low carbon aluminum-killed steel, t: 0.3 mm, Cylindrical diameter: φ18 mm, Height: 65 mm

Calculated average roughness Ra of side surface portion outer peripheral surface and bottom end surface in main body of exterior portion: 1.1 μm·Terminal material on upper surface side: Steel sheet·Material of washer: PPE (polyphenylene ether)·Electrolytic solution: (EC+DMC+EMC+LiPF₆+LiBF₄+FEC)·Positive electrode active material: Nickel-based lithium cobaltate·Negative electrode active material: Graphite·Current collecting foil: Positive electrode side Al, thickness 12 μm, negative electrode side Cu, thickness 10 μm

After the production of the cylindrical secondary battery, a test for checking the tracking short circuit of the prepared cylindrical secondary battery was conducted. Specifically, first, a battery charged at a constant voltage of 4.20 V and a constant current of 4.0 A for 5 hours in an atmosphere of 23±2° C. was prepared as a battery in a standard state.

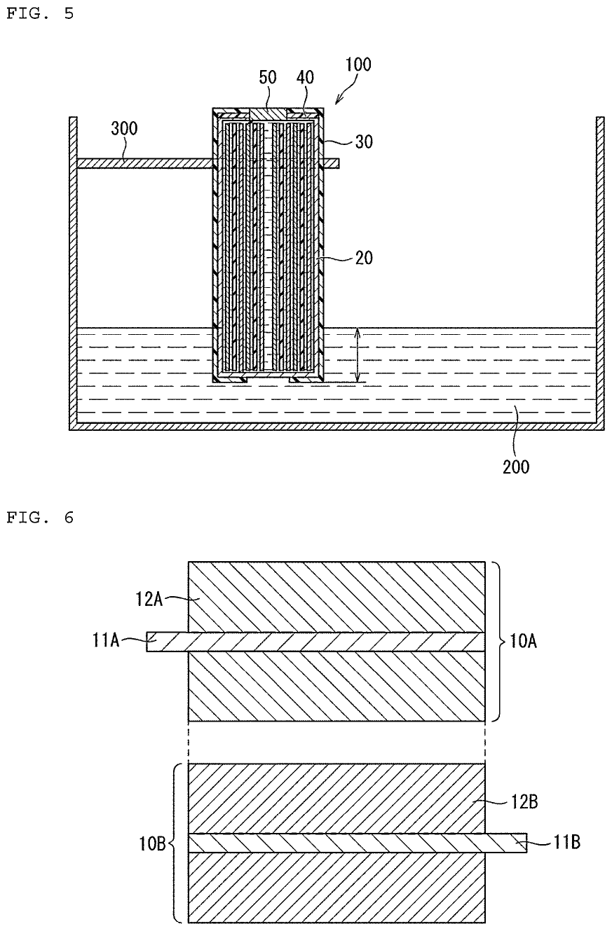

After preparing the battery in the standard state, the bottom surface of a cylindrical secondary battery 100 was immersed in a tank water 200 by 20 mm in a state where the cylindrical secondary battery 100 was held by a holding portion 300 as shown in FIG. 5 in accordance with the BYREC method of JIS L 1907. An immersion time was 24 hours. The number of batteries evaluated in this tracking short circuit test was determined to be 100.

After immersion for 24 hours, it was determined how many batteries among the 100 evaluated batteries satisfied an open voltage value of a predetermined value (4.0 V) or more using an open circuit voltage (OCV) tester. Specifically, a case where the number of batteries having an open voltage value of 4.0 V or more was 95 or more was determined to pass the test, and a case where the number of batteries having an open voltage value of 4.0 V or more was less than 95, or a case where the open voltage value of the battery was less than 4.0 V was determined to fail the test. The open circuit voltage (OCV) tester manufactured by HIOKI E.E. CORPORATION was used.

### Example 2

Example 2 was different from Example 1 in the following points, and the remaining points were the same.

(Difference)·Point using following covering portion (heat shrinkable tube)
Rz of inner surface in battery radial direction: 2.5 μm
Rz of inner surface in battery longitudinal direction: 2.0 μm

### Comparative Example

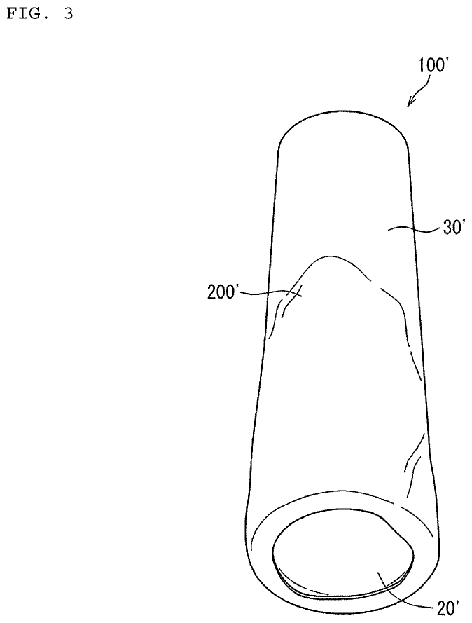

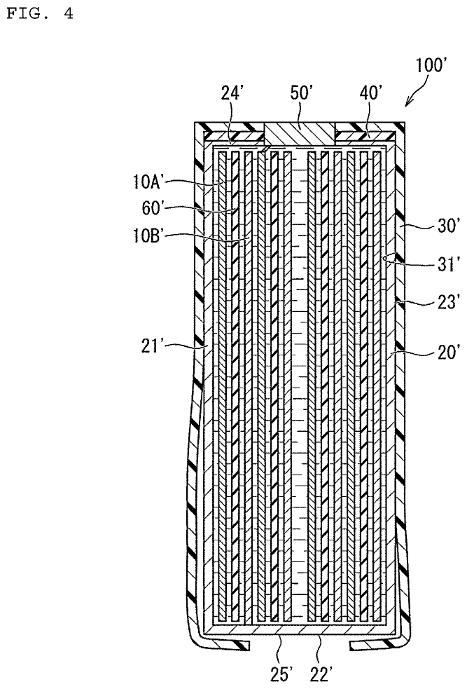

Comparative Example was different from Examples 1 and 2 in the following points, and the remaining points were the same. In FIGS. 3 and 4 corresponding to Comparative Example, '(dash) is added to the reference numeral from the viewpoint of facilitating comparison with FIGS. 1 and 2 corresponding to Examples 1 and 2.

(Difference)·Point using following covering portion (heat shrinkable tube)
Rz of inner surface in battery radial direction: 3.0 μm
Rz of inner surface in battery longitudinal direction: 2.5 μm

### [Measurement Results] Example 1

Of the 100 evaluated batteries, 95 batteries satisfied the criterion of an open voltage value of 4.0 V or more, and Example 1 was determined to pass the test.

### Example 2

Of the 100 evaluated batteries, 99 batteries satisfied the criterion of an open voltage value of 4.0 V or more, and Example 2 was determined to pass the test.

### Comparative Example

Of the 100 evaluated batteries, only 90 batteries satisfied the criterion of an open voltage value of 4.0 V or more, and Comparative Example was determined to fail the test.

[Discussion]·The comparison of the measurement results between Example 1 and Comparative Example showed that when the calculated average roughness (Ra) of the cylindrical main body is a predetermined value and the maximum height roughness (Rz) of the inner surface 31 of the covering portion 30 in the radial direction of the battery is 2.5 μm or less, moisture infiltration from the bottom of the exterior portion 20 into a space between the exterior portion 20 and the covering portion 30, that is, the rising of moisture is suppressed, and as a result, a tracking phenomenon is suppressed.
The comparison of the measurement results of Examples 1 and 2 and Comparative Example showed that when the maximum height roughness (Rz) of the inner surface of the covering portion 30 in the longitudinal direction in addition to the radial direction of the battery is 2.0 μm or less, the further rising of moisture through between the side surface portion of the exterior portion 20 and the covering portion 30 is suppressed, and as a result, the tracking phenomenon is further suppressed.
Meanwhile, in Comparative Example, the maximum height roughness (Rz) of the inner surface of the covering portion 30′ in the radial direction and the longitudinal direction of the battery was larger than the above-described predetermined value, and thus moisture 200′ was confirmed to pass through between the bottom/side surface portion of the exterior portion 20′ and the covering portion 30′ (see FIG. 3).
From the above, it was also found that when the calculated average roughness (Ra) of the cylindrical main body is the predetermined value, the adhesion between the inner surface of the covering portion 30 and the surface of the exterior portion 20 in the radial direction of the battery can be improved by setting at least the maximum height roughness (Rz) of the inner surface of the covering portion 30 in the radial direction of the battery to a predetermined value (2.5 μm) or less.
Furthermore, it was found that when the maximum height roughness (Rz) of the inner surface of the covering portion 30 in the longitudinal direction of the battery as well as in the radial direction of the battery is set to a predetermined value (2.0 μm) or less, as a whole of the cylindrical secondary battery 100, the adhesion between the inner surface of the covering portion 30 and the surface of the exterior portion 20 can be further improved.

The present disclosure can include the following aspects according to an embodiment.
<1>

A cylindrical secondary battery including:
a cylindrical exterior portion including a battery element therein and including opposite end portions and an outer peripheral surface disposed therebetween; and
a covering portion covering at least a part of both the end portions of the exterior portion and an entire outer peripheral surface,
wherein
the exterior portion includes a cylindrical main body having an opening on one end side and a bottom on another end side opposite to the one end side, and a lid closing the opening,
a calculated average roughness (Ra) of the cylindrical main body is 0.7 to 1.5 μm, and
a maximum height roughness (Rz) of an inner surface of the covering portion in a radial direction of the bottom of the main body is 2.5 μm or less.
<2>

The cylindrical secondary battery according to <1>, wherein the maximum height roughness (Rz) of the inner surface of the covering portion in a longitudinal direction of the battery is 2.0 μm or less.
<3>

The cylindrical secondary battery according to <1> or <2>, wherein the covering portion has a thickness of 30 μm or more and 150 μm or less.
<4>

The cylindrical secondary battery according to any one of <1> to <3>, wherein the covering portion contains a polyester-based resin.
<5>

The cylindrical secondary battery according to any one of <1> to <4>, wherein the covering portion is a heat shrinkable tube.

A cylindrical secondary battery according to an embodiment of the present disclosure is used, for example, as a power supply of electrically-powered equipment.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A cylindrical secondary battery comprising:
a cylindrical exterior portion including a battery element therein and including opposite end portions and an outer peripheral surface disposed therebetween; and
a covering portion covering at least a part of both the end portions of the exterior portion and an entire outer peripheral surface,
wherein
the exterior portion includes a cylindrical main body having an opening on one end side and a bottom on another end side opposite to the one end side, and a lid closing the opening,
a calculated average roughness (Ra) of the cylindrical main body is 0.7 to 1.5 μm, and
a maximum height roughness (Rz) of an inner surface of the covering portion in a radial direction of the bottom of the main body is 2.5 μm or less.

2. The cylindrical secondary battery according to claim 1, wherein the maximum height roughness (Rz) of the inner surface of the covering portion in a longitudinal direction of the battery is 2.0 μm or less.

3. The cylindrical secondary battery according to claim 1, wherein the covering portion has a thickness of 30 μm or more and 150 μm or less.

4. The cylindrical secondary battery according to claim 1, wherein the covering portion includes a polyester-based resin.

5. The cylindrical secondary battery according to claim 1, wherein the covering portion is a heat shrinkable tube.
